(19) United States
(12) Patent Application Publication
(10) Pub. No.: US 2005/0270254 A1
(43) Pub. Date: Dec. 8, 2005

(54) Control circuit of display device, display device and electronic appliance having the same, and driving method of the same

(76) Inventor: Tadafumi Ozaki, Atsugi (JP)

Correspondence Address: FISH & RICHARDSON P.C., P.O. BOX 1022, MINNEAPOLIS, MN, 55440-1022, US

(21) Appl. No.: 11/146,238

(22) Filed: Jun. 7, 2005

(30) Foreign Application Priority Data
Jun. 8, 2004 (JP) 2004-169392

(51) Int. Cl. G09G 3/36

(52) U.S. Cl. 345/63; 345/89

(57) ABSTRACT

Downsizing and improvement in operating efficiency of a control circuit of a display device is achieved. Two video data storage units that have conventionally been used in a control circuit are combined into one, and an address area thereof is divided in half. One of the areas is used as a writing area while the other is used as a reading area, and these areas are alternately switched at regular intervals, for example per frame period. Video data reading from the video data storage unit is performed not in synchronous with a half-cycle of a source clock. Instead, a predetermined quantity of video data is read out continuously in a plurality of consecutive clock cycles, and the video data is temporarily held in a read-out video data storage unit and the like so as to be transmitted to a display panel at any time desired. Write-in operation is performed in the period in which the read-out operation is not performed until a write-in video data storage unit is completely rewritten.

### BACKGROUND OF THE INVENTION

1. Field of the Invention

The present invention relates to a display device, and more particularly to a display device comprising a display panel having pixels each of which includes a light emitting element, and a control circuit having a storage means for storing video data.

Control circuit of a display device means a circuit for converting a video signal received in format to the video data enabling a gray scale display in pixels of a display panel, writing the video data to a storage means, and then outputting the video data read out from the storage means to the display panel.

2. Description of the Related Art

There is known a display device comprising a display panel having pixels each of which includes a light emitting element, and a peripheral circuit for inputting signals to the display panel, in which images are displayed by controlling the emission of the light emitting elements.

In such a display panel of the display device, two or three TFTs (Thin Film Transistors) are typically disposed in each pixel, and the luminance and emission/non-emission of the light emitting element in each pixel are controlled by controlling ON/OFF of the TFTs. On the periphery of the pixel portion of the display panel, a driver circuit for controlling ON/OFF of the TFTs in each pixel is provided. Such a driver circuit is constructed of TFTs that are formed simultaneously with the TFTs in the pixel portion. Such TFTs may be either N-channel TFTs or P-channel TFTs.

In the pixel having the aforementioned configuration, two types of gray scale methods: an analog gray scale method and a digital gray scale method can be used. In particular, the digital gray scale method is advantageous in that it is hardly affected by characteristic variations of TFTs. As the digital gray scale method, there are a time gray scale method and an area gray scale method.

According to the time gray scale method, gray scales are displayed by controlling the emission period of each pixel of a display device. Assuming that a period for displaying one image is one frame period, the one frame period is divided into a plurality of sub-frame periods. By controlling the emission/non-emission of each pixel (specifically, by controlling the emission/non-emission of a light emitting element in each pixel) in each sub-frame period, setting each sub-frame period to have a squared length of the previous sub-frame period (varying the display period of each sub-frame period), and selecting each sub-frame period (selecting several sub-frame periods during which pixels emit light) to control the total emission period, gray scales are displayed in each pixel.

According to the area gray scale method, gray scales are displayed by controlling the emission area of each pixel in the display device. Specifically, each pixel is divided into a plurality of sub-pixels, and the number of the sub-pixels selected for emission is controlled to display gray scales in each pixel.

In a display device where gray scales are displayed using such a time gray scale method or an area gray scale method, a control circuit is used, which converts a video signal received in format to the video data appropriate for a time gray scale display or an area gray scale display, and outputs the video data to a display panel.

As such a control circuit of a display device, for example, there is a circuit for a display device with a time gray scale method as disclosed in Patent Document 1, which is shown in FIG. 14. The control circuit shown in FIG. 14 comprises a write-in circuit including a format converting unit 1401 for converting first video data into second video data for display with a time gray scale method, first and second video memories 1402 and 1403 for storing the second video data, a read-out circuit including a display control unit 1404 for reading out data from the memories and transmitting the data to a display panel, and a selection circuit for selecting the memories to write-in/read-out data. That is, the control circuit of the Patent Document 1 uses two memories, and one of them is used for reading while the other is used for writing at a certain point.

In the aforementioned conventional configuration, it is required that video data be transmitted to a display panel in synchronous with a source clock signal (hereinafter referred to as “S_CK”), and the video data be read out from the video memory in synchronous with a half-cycle of the S_CK. FIG. 15 is a timing chart illustrating the read-out timing from the memory in the aforementioned conventional configuration where an internal clock (CLK) frequency is 60 MHz, and the half-cycle of S_CK is 100 ns. In the timing chart, a read-out control signal (OEB) that is at L level in the read-out operation is in the enabled state (L level) in synchronous with the half-cycle of the S_CK.

[Patent Document 1] Japanese Patent Application No. 2003-361179

However, the aforementioned conventional configuration involves a time margin for the period after the termination of the read-out operation for one address until the start of the next data read-out operation, since data reading from the video memory is required to be performed in synchronous with the half-cycle of S_CK, which results in inefficient utilization of time.

In addition, in the aforementioned conventional configuration, there may be a case where a physical area of the memory cannot be used efficiently. For example, as shown in “the case where no first read-out video data storage unit is provided” in FIG. 10A, a case is considered where one address of a memory has 16 bits, and an image is displayed in a display panel by reading out video data for 8 pixels×RGB all at once. When adopting such conventional configuration, video data for 8 pixels×RGB is divided into upper 12 bits (4 bits×RGB) and lower 12 bits (4 bits×RGB), each of which is stored in one address. In that case, two addresses are read out in series within a half-cycle of S_CK Thus, 4 bits of the 16 bits of one address is not utilized, resulting in inefficient utilization of the physical area of the memory.

Further, in the aforementioned conventional configuration, two video memories are required as a main storage device. Therefore, a larger area of circuit elements over the substrate and a larger number of mounting pins are required, which would prevent downsizing and reduction in production cost of a product. In addition, if a single video memory is used, which has an address area divided in half to be used for read-out operation and write-in operation, memory access is required to be performed at least three times (two reading-in and one writing-out) in a half-cycle of S_CK in the case of accessing the memory within the half-cycle of S_CK Thus, the memory access timing has a narrow margin, and such requirements are posed that a memory with large power consumption be used as well as the internal clock frequency be increased with the use of a high-performance device, or the like, which would prevent reduction in production cost, improvement in reliability of the circuit and reduction in power consumption.

### SUMMARY OF THE INVENTION

The invention is made in order to solve the foregoing problems of the conventional techniques, and it is a primary object of the invention to provide a control circuit of a display device having a configuration where a single main video data memory is used without the need of the aforementioned requirements, and having an improved operating efficiency. In addition, the invention provides a display device and an electronic appliance incorporating the same, and a driving method of the same.

In order to achieve the aforementioned object, the control circuit of a display device of the invention uses a single main video data memory, and video data reading is performed not in synchronous with a half-cycle of S_CK. Instead, a predetermined quantity of video data or video data for one-row display is read out continuously in the S_CK cycle all at once, and data writing to the memory is performed in the period in which the read-out operation is not performed.

Specifically, the control circuit of a display device of the invention comprises a main video data storage means including first and second areas for storing video data, a read-out means for reading out the video data from one of the first and second areas of the main video data storage means and supplying the video data to a display panel, and a write-in means for converting a video signal supplied in format to the video data enabling a gray scale display in the display device, and writes the video data to one of the first and second areas of the main video data storage means that is not being read out while the read-out operation of the video data is not performed, wherein the readout means switches the first and second areas to be read out the video data in each period in which one or more images are displayed, and the read-out means reads out from the main video data storage means, a predetermined quantity of video data appropriate for the display timing of the display panel in a plurality of consecutive clock cycles.

Accordingly, only a single memory is required as the main video data storage means, which does not cause a problem concerning the memory access timing. Therefore, reduction in the number of mounting pins, simpler configuration and smaller circuit scale can be achieved as well as the utilization efficiency of the physical area of the memory can be improved without the need of a memory with large power consumption, increase in the internal clock frequency with the use of a high-performance device, or the like.

In addition, the read-out means may include a read-out video data storage means for holding the predetermined quantity of video data for a fixed hold period. The read-out video data storage means may include a first read-out video data storage means for holding video data that is read out from the main video storage means for a fixed period, and a second read-out video data storage means for reading out video data from the first read-out video data storage means all at once at regular intervals.

The read-out means may be incorporated into one integrated circuit. Incorporation of each component constituting the read-out means into one integrated circuit facilitates downsizing of the circuit as well as the simpler configuration of the circuit, which leads to the improvement in reliability and reduction in production cost. Each component constituting the read-out means may be in either mode where the whole components are incorporated into one integrated circuit or where they are provided as different integrated circuits.

In addition, the write-in means may include a write-in video data storage means for holding the predetermined quantity of video data that is appropriate for being written to the main video data storage means for a fixed write-in video data hold period so as to write the video data to the main video data storage means.

Further, the write-in means may include an excess video data storage means for temporarily holding a part of the predetermined quantity of video data held in the write-in video data storage means, which has not been written to the main video data storage means during the write-in video data hold period, and for writing the video data to the main video data storage means while the read-out operation of the video data is not performed.

As another embodiment mode of the invention, a driving method of a control circuit of a display device, which converts a video signal supplied in format to the video data enabling a gray scale display in the display device to be supplied to a display panel, and which comprises a main video data storage means including first and second areas for storing the video data, comprises the steps of reading out a predetermined quantity of video data appropriate for the display timing of the display panel continuously in a plurality of consecutive clock cycles from one of the first and second areas of the main video data storage means, supplying video data read out from the main video data storage means to the display panel, converting the video signal supplied in format to the video data, writing the video data to one of the first and second areas of the main video data storage means that is not being read out while the read-out operation of the video data is not performed, and switching the first and second areas to be read out the video data in each period for displaying one or more images.

According to such a method, only a single memory is required as the main video data storage means in the control circuit of the display device, which does not cause a problem concerning the memory access timing. Therefore, reduction in the number of mounting pins, simpler configuration and smaller circuit scale can be achieved as well as the utilization efficiency of the physical area of the memory can be improved without the need of a memory with large power consumption, increase in the internal clock frequency with the use of a high-performance device, or the like.

A display device incorporating the control circuit of the invention may include the control circuit of the invention and a display panel having pixels each of which includes a light emitting element.

Accordingly, downsizing and reduction in production cost of the control circuit can be achieved, thereby downsizing and reduction in production cost of the display device can be achieved. The display device incorporating the control circuit of the invention can be driven with an area gray scale method or a time gray scale method to perform gray scale display. In addition, a light emitting element typified by an EL (Electro Luminescence) element includes a pair of electrodes and a layer containing a light emitting material provided therebetween. The light emitting element generates one or both of light emitted in returning from an excited singlet state to a ground state (fluorescence) and light emitted in returning from an excited triplet state to a ground state (phosphorescence).

As set forth above, according to the control circuit of a display device of the invention, a single main video data storage means is used, and video data reading is performed not in synchronous with a half-cycle of S_CK Instead, a predetermined quantity of video data or video data for one-row display is read out continuously in the S_CK cycle all at once, and data writing to the memory is performed in the period in which the read-out operation is not performed. Therefore, reduction in the number of mounting pins, simpler configuration and smaller circuit scale can be achieved as well as the utilization efficiency of the physical area of the memory can be improved without the need of a memory with large power consumption, increase in the internal clock frequency with the use of a high-performance device, or the like. As a result, downsizing, reduction in production cost, improvement in reliability and reduction in power consumption can be achieved in a display device and an electronic appliance each comprising the control circuit of the invention.

### BRIEF DESCRIPTION OF THE DRAWINGS

FIG. 1A is a block diagram illustrating an exemplary configuration of a control circuit of the invention according to Embodiment Mode 1.

FIG. 1B is a block diagram illustrating an exemplary configuration of a control circuit of the invention according to Embodiment Mode 1.

FIG. 1C is a timing chart illustrating the operation of two memories included in the control circuit of FIGS. 1A and 1B.

FIG. 2 is a timing chart illustrating the operation of a control circuit of the invention.

FIG. 3 is a timing chart illustrating a relationship between the write-in operation and the read-out operation of video data by a control circuit of the invention according to Embodiment Mode 1.

FIG. 4 is a timing chart illustrating a relationship between the write-in operation and the read-out operation of video data by the control circuit of the invention according to Embodiment Mode 1, in the case where data writing to a write-in video data storage unit cannot be completed within the data hold period.

FIG. 5 is a schematic chart of a display break period after completion of a sub-frame.

FIG. 6 is a schematic chart of a reception break period between adjacent frames and rows.

FIG. 7 is a block diagram illustrating an exemplary configuration of a control circuit of a display device of the invention according to Embodiment Mode 2.

FIG. 8 is a timing chart of the write-in operation and the read-out operation of video data by a control circuit of the invention according to Embodiment Mode 2.

FIGS. 9A and 9B are charts illustrating an advantage of using a read-out video data storage unit in terms of the utilization of time.

FIGS. 10A and 10B are charts illustrating an advantage of the usage of a memory area by a read-out video data storage unit.

FIG. 11A is a schematic diagram illustrating an exemplary display device using the invention.

FIG 11B is a schematic diagram illustrating another exemplary display device using the invention.

FIG. 12A is a circuit diagram of a pixel portion of the display device in FIG. 11A and FIG. 12B is a circuit diagram of a pixel portion of the display device in FIG. 11B.

FIGS. 13A to 13H are exemplary electronic appliances each using the invention.

FIG. 14 is a block diagram illustrating a control circuit of a conventional display device.

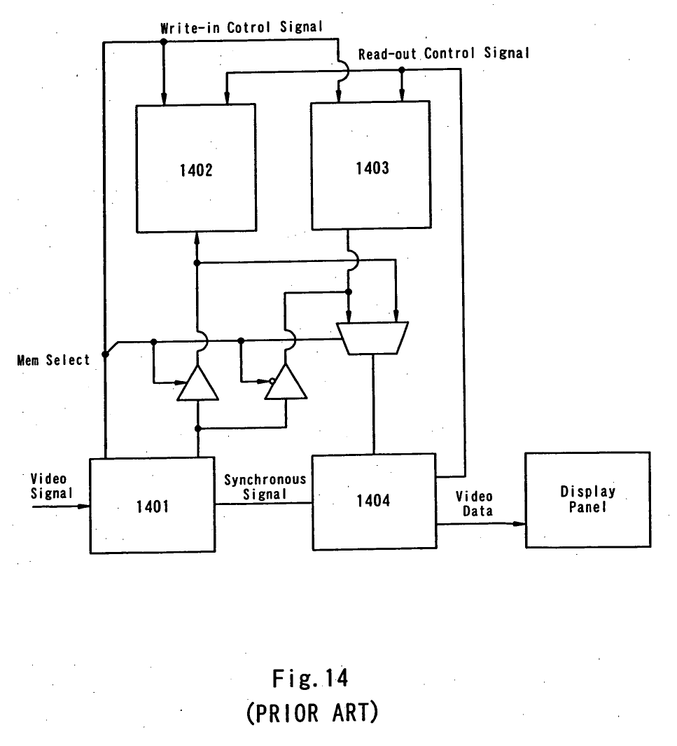

FIG. 15 is a timing chart illustrating the read-out operation of video data by a control circuit of a conventional display device.

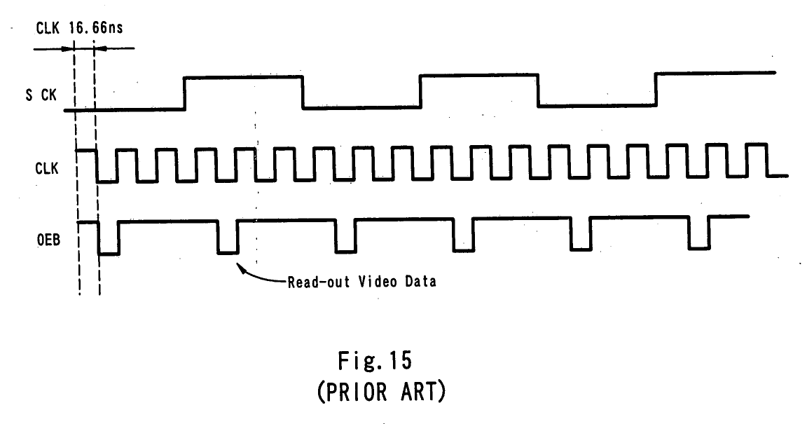

### DETAILED DESCRIPTION OF THE PREFERRED EMBODIMENTS

### Embodiment Mode 1

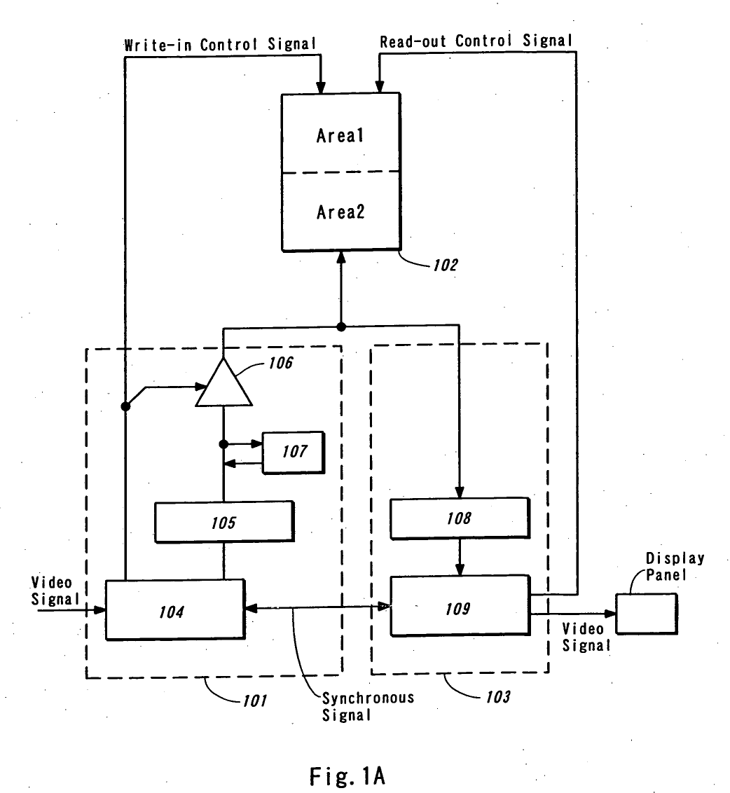

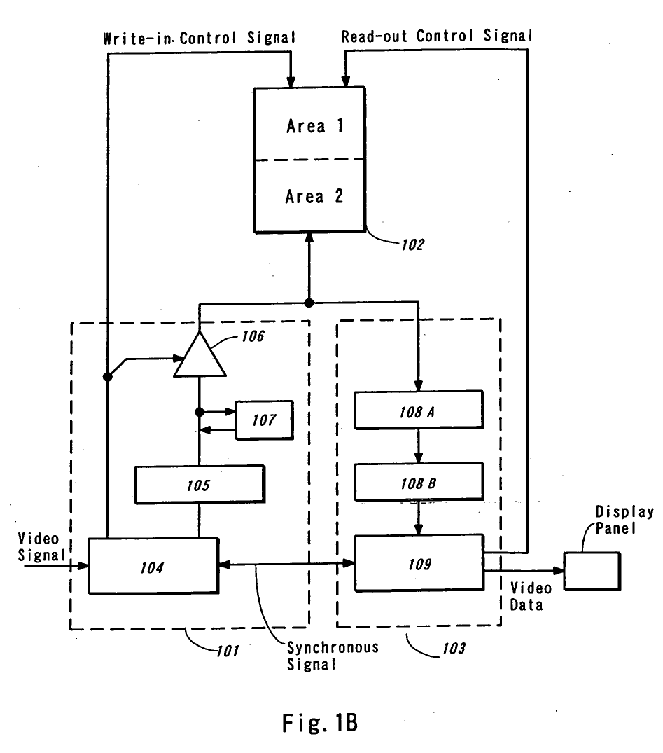

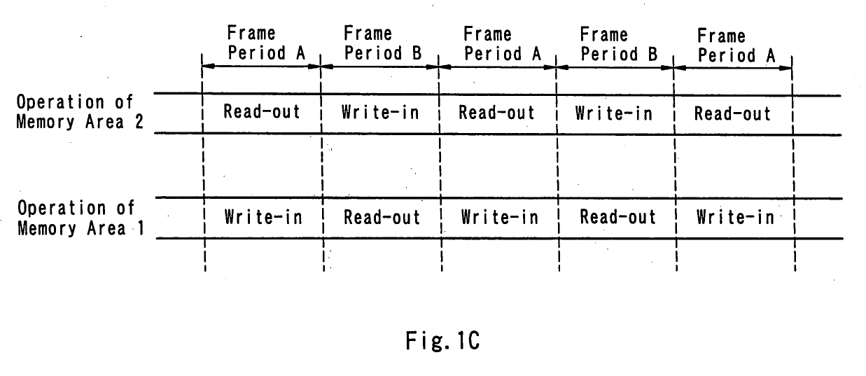

FIG. 1A schematically illustrates an exemplary configuration of a control circuit of a display device of the invention. The control circuit comprises a video data write-in circuit 101 including a video data format converting unit 104 and a write-in video data storage unit 105, a main video data storage unit 102, and a video data read-out circuit 103 including a read-out video data storage unit 108 and a display control unit 109. Upon receiving a video signal, the video data format converting unit 104 converts the video signal in format, for example to the video data appropriate for a time gray scale display in pixels of a display panel if the display device is driven with the time gray scale method, and then writes the video data having the converted format to the write-in video data storage unit 105. The write-in video data storage unit 105 holds a predetermined quantity of video data appropriate for being written to the main video data storage unit 102 for a fixed period, and then writes the video data to the main video data storage unit 102 through a tri-state buffer 106 at appropriate timing. The period in which the video data storage unit 105 holds a predetermined quantity of video data is referred to as a write-in video data hold period. Instead of the tri-state buffer 106, other connection control means such as an analog switch may be employed. The read-out video data storage unit 108 holds a predetermined quantity of video data read out from the main video data storage unit 102 for a fixed period, and the video data held in the read-out video data storage unit 108 is transmitted through the display control unit 109 to the display panel in synchronous with the display timing. Video data held in the read-out video data storage unit 108 for a fixed period is the video data having an appropriate quantity for the display timing of the display panel.

Unlike the conventional techniques, a single memory is used as the main video data storage unit 102. An address area of the single memory is divided into a memory area 1 and a memory area 2, and one of them is used for read-out operation while the other is used for write-in operation. These functions are switched alternately in each frame. Specifically, as shown in FIG. 1C, in a certain frame period, video data is read out from the memory area 1 while the memory area 2 is written with video data obtained by format conversion of a video signal received. In the subsequent frame period, vice versa, the memory area 1 is used for writing while the memory are 2 is used for reading.

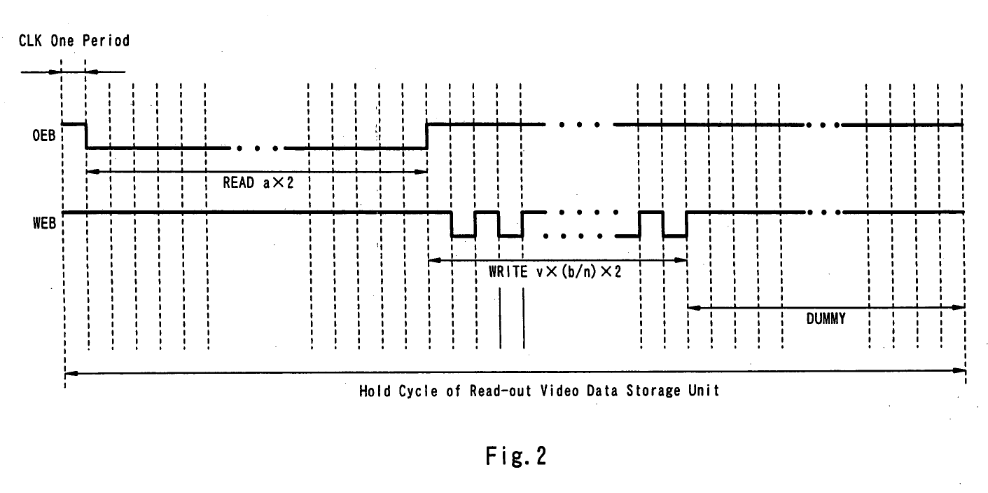

FIG. 2 is a timing chart illustrating the operation timing of the control circuit in FIG. 1A when video data for one frame is transmitted to the display panel. Shown here as an example is the case where one address of the video memory is assigned with one video bit of n-pixels (n is a natural number)×RGB, the number of the video bits is v (v is a natural number), and the memory is accessed in two cycles of a clock signal (CLK). For example, when one address of the main video data storage unit 102 is assigned with one video bit of 5 pixels×RGB (n=5), and the number of the video bits is 6 (v=6), write-in access to the main video data storage unit 102 is required to be performed 6 times, namely in 12 clock cycles within 5 reception cycles in order to store video data for 5 pixels in the main video data storage unit 102. Note that when the number of the video bits is v, 2^{v} gray scales are displayed with light emitting elements (RGB) in each pixel. When the number of the video bits v is 6, 2⁶=64 gray scales are displayed.

According to the operation of such a control circuit, read-out operation is performed not in synchronous with a half-cycle of S_CK unlike the conventional techniques, but the read-out operation is performed continuously in the period of predetermined clock cycles as a base period. For example, in one frame period, video data of a×n×RGB (a is a natural number) bits, namely video data stored in a addresses is continuously read out from the first memory area of the main video data storage unit 102 shown in FIG. 1A, and temporarily stored in the read-out video data storage unit 108. Meanwhile, video data for reception cycles×b (b is a natural number), namely video data for b pixels is stored in the write-in video data storage unit 105, and the video data is written to the second memory area of the main video data storage unit 102 in the period in which the read-out operation from the first memory area is not performed. That is, as shown in FIG. 2, in the hold cycle of the read-out video data storage unit 108, the read-out operation is performed by changing addresses with a read-out control signal OEB being set in the enabled state for a×2 clock cycles, and then the write-in operation is performed with a write-in control signal WEB being set in the enabled state for v×(b/n) 2 cycles. The remaining period of the frame period is a redundant period (denoted by DUMMY in the chart). Although FIG. 2 illustrates an example where the read-out operation is performed only by changing addresses with a read-out control signal OEB being kept in the enabled state, the OEB may be set in the disabled state each time data is read out from each address.

The timing chart in FIG. 2 schematically illustrates a mutually exclusive relationship between the read-out operation period, the write-in operation period and the redundant period, in which the read-out operation and the write-in operation are each performed once in one frame period, however, each of the read-out operation and the write-in operation is not necessarily performed once in one frame period since the read-out timing and the write-in timing of the memory are asynchronous with each other.

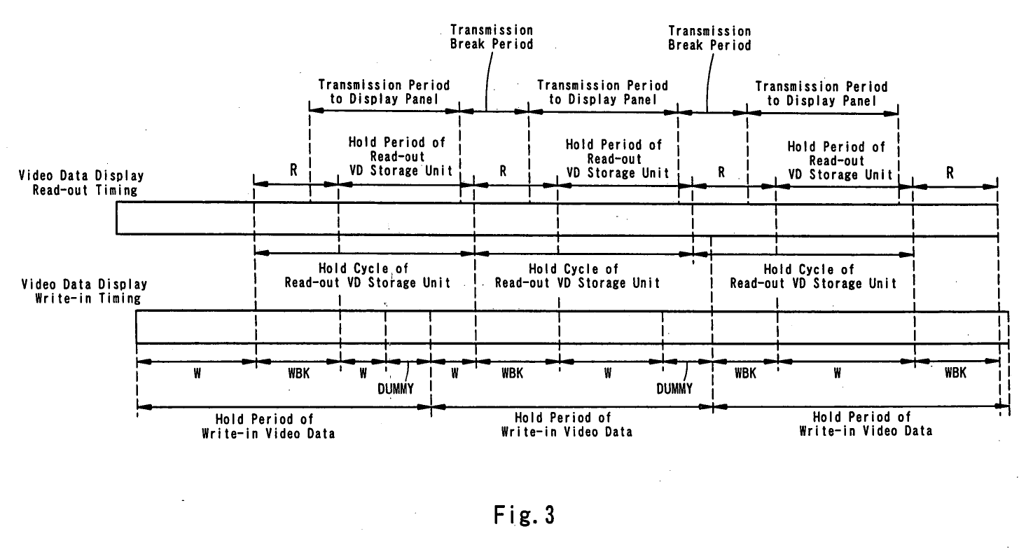

FIG. 3 illustrates the actual timing of the read-out operation and the write-in operation of the control circuit in FIG. 1A. As shown in FIG. 3, the read-out timing and the write-in timing of the main video data storage unit 102 are asynchronous with each other, therefore, a plurality of read-out operations and write-in operations are alternately performed in one frame period.

Referring to the timing of the read-out operation for display in FIG. 3, one hold cycle of the read-out video data storage unit 108 includes a video data read-out period R in which video data for a×n pixels is read out from the main video data storage unit 102 to be stored in the read-out video data storage unit 108, and a hold period (period after the period R until the termination of the hold cycle) in which the video data read out is held in the read-out video data storage unit 108. The video data that has been read out and stored in the read-out video data storage unit 108 is transmitted to the display panel at any time required during the hold cycle. The period after transmission of the video data for a×n pixels read out in the period R to the display panel, until the start of the transmission of video data read out in the next hold cycle corresponds to a transmission break period.

Referring to the timing of the write-in operation, the write-in operation is performed in the period in which the read-out operation is not performed. That is, content of the write-in video data storage unit 105 is written to the main video data storage unit 102 in a write-in period W (a period other than the video data read-out period R, within the write-in video data hold period in which a predetermined quantity of video data is held in the write-in video data storage unit 105). On the other hand, a write-in break period WBK, in which no write-in operation is performed, within the write-in video data hold period corresponds to the video data read-out period R of the read-out video data storage unit 108. A DUMMY is a redundant period within one write-in video data hold period, which corresponds to the period after the whole content of the write-in video data storage unit 105 is written to the writing area of the main video data storage unit 102, until the write-in video data storage unit 105 is completely rewritten.

FIG. 1B schematically illustrates an exemplary configuration of a control circuit of a display device of the invention, which corresponds to the partially modified control circuit in FIG. 1A. FIG. 1B has a different configuration from the control circuit in FIG. 1A in that a first read-out video data storage unit 108A and a second read-out video data storage unit 108B are provided instead of the read-out video data storage unit 108 in the video data read-out circuit 103.

In the control circuit in FIG. 1A, the display control unit 109 transmits a content of the read-out video data storage unit 108 to the display panel in synchronous with the display timing, however, as shown in FIG 3, a transmission break period is provided between the adjacent transmission periods to the display panel. In the transmission break period mainly, the read-out video data storage unit 108 reads out data from the main video data storage unit 102. When the transmission break period is sufficiently long, transmission may be performed smoothly by reading out the content of the read-out video data storage circuit 108 directly by the display control unit 109.

However, when the transmission break period is short, the whole content of the main video data storage unit 102 cannot be read out by the read-out video data storage unit 108 by the next data transmission to the display panel if the content of the read-out video data storage unit 108, which reads out data from the main video data storage unit 102, is directly read out by the display control unit 109. Thus, a configuration shown in FIG. 1B is employed, which has the first read-out video data storage unit 108A and the second read-out video data storage unit 108B. That is, in the control circuit in FIG. 1B, the first read-out video data storage unit 108A has a similar function to the read-out video data storage unit 108 in FIG. 1A with regard to the read-out operation. However, as the content of the first read-out video data storage unit 108A is read out and stored by the second read-out video data storage unit 108B provided between the first read-out video data storage unit 108A and the display panel all at once at regular intervals, the read-out operation of the first read-out video data storage unit 108A from the main video data storage unit 102 is not adversely affected even when the transmission break period is short. Accordingly, even when the transmission break period is short, such problem does not occur that the whole content of the main video data storage unit 102 cannot be read out by the video data read-out circuit 103 by the next data transmission to the display panel.

In the configurations in FIGS. 1A and 1B, an excess video data storage unit 107 is provided between the write-in video data storage unit 105 of the video data write-in circuit 101 and the main video data storage unit 102. As described above with reference to FIG. 3, the write-in video data storage unit 105 performs the write-in operation in the period (write-in period W) other than the period in which read-out operation is performed (read-out period R) during the write-in video data hold period. Typically, a period obtained by subtracting the read-out period R (or the write-in break period WBK) from the write-in video data hold period is long enough to still have a redundant period (DUMMY) even when securing the write-in period to be long enough to write the whole predetermined quantity of video data held in the write-in video data storage unit. However, as described below, depending on the length or timing of each read-out period and write-in period, a write-in period, which is long enough to write the whole content of the write-in video data storage unit in the write-in video data storage period, cannot be secured, which would cause excess write-in video data. When such a problem occurs, the excess video data storage unit 107 is provided between the write-in video data storage unit 105 and the main video data storage unit 102, and the excess video data that has not been written during the hold period of the write-in video data storage unit is temporarily stored, in which case the excess video data is written in the redundant period (DUMMY) or other periods. Otherwise, if the problem of the excess write-in video data as set forth above does not occur, the excess video data storage unit 107 is not required.

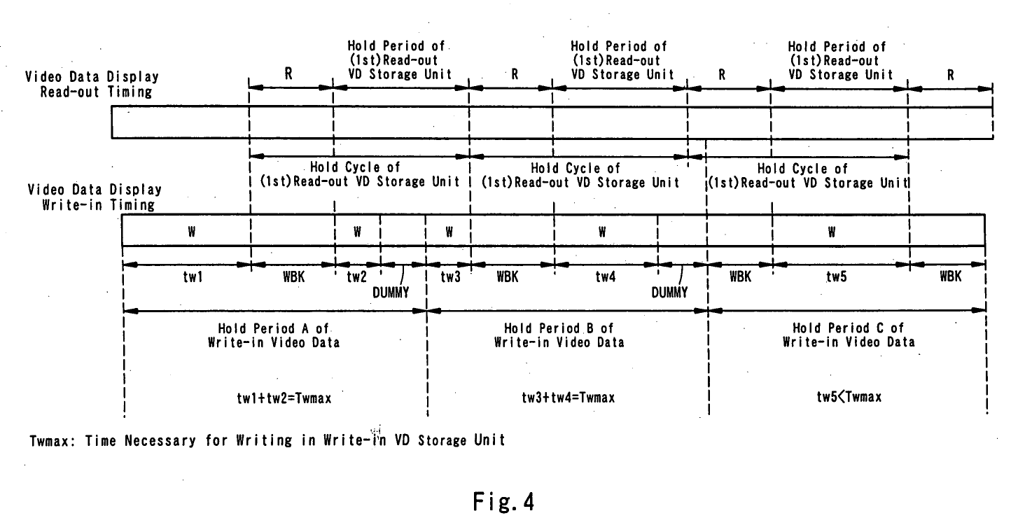

FIG. 4 is a timing chart illustrating a relationship between the write-in period W and a period Twmax that is necessary for the whole predetermined quantity of video data held in the write-in video data storage unit to be written (time necessary for writing). The total length of the write-in periods W in the write-in video data hold period A equals to (tw1+tw2), and the total length of the write-in periods W in the write-in video data hold period B equals to (tw3+tw4), each of which is shorter than the period necessary for writing (Twmax), thus the redundant period DUMMY can be secured, which would not cause the excess write-in video data. However, in the write-in video data hold period C, the total length of the write-in period W (tw5) is longer than the period necessary for writing (Twmax), which would cause the excess write-in video data. In order to avoid such condition, the excess video data storage unit 107 is required.

The excess video data that is temporarily held in the excess video data storage unit 107 is written to the main video data storage unit 102 in the redundant period DUMMY as well as the display break period after completion of a sub-frame period, the reception break period between adjacent rows, the reception break period between adjacent frames, and the like.

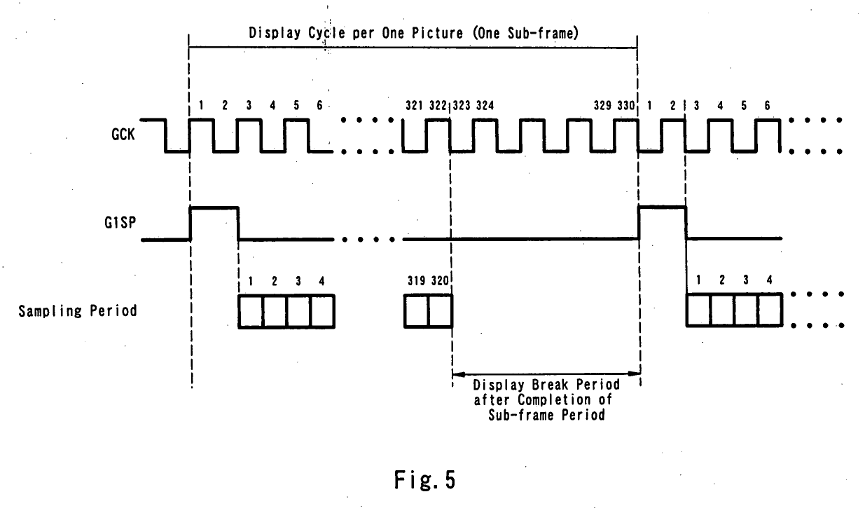

FIG. 5 is a timing chart illustrating the display break period after completion of a sub-frame period, in which the excess video data can be written. FIG. 5 illustrates as an example the display control timing of a display panel having 320 rows of pixels. First, upon input of a pulse signal G1SP at the beginning of a sub-frame period, video data for one row is sequentially inputted to the display panel in each half-cycle of a clock signal (GCK). The video data input period is indicated by a sampling period from 1 to 320 rows in FIG. 5. In the video data input period, video data for one row is read out from a video memory in each half-cycle of the clock signal (GCK). After the input of the video data for 320 rows until the start of the next sub-frame period, another period is generally provided, in which the input of video data to the display panel is suspended (hereinafter referred to as a display break period after completion of a sub-frame period). The display break period after completion of a sub-frame period shown as an example in FIG. 5 is long enough to accommodate 8 half-cycles of the clock signal (GCK) of the video data. The display break period after completion of a sub-frame period can be utilized for writing excess video data as there is no need to perform the read-out operation from the video memory.

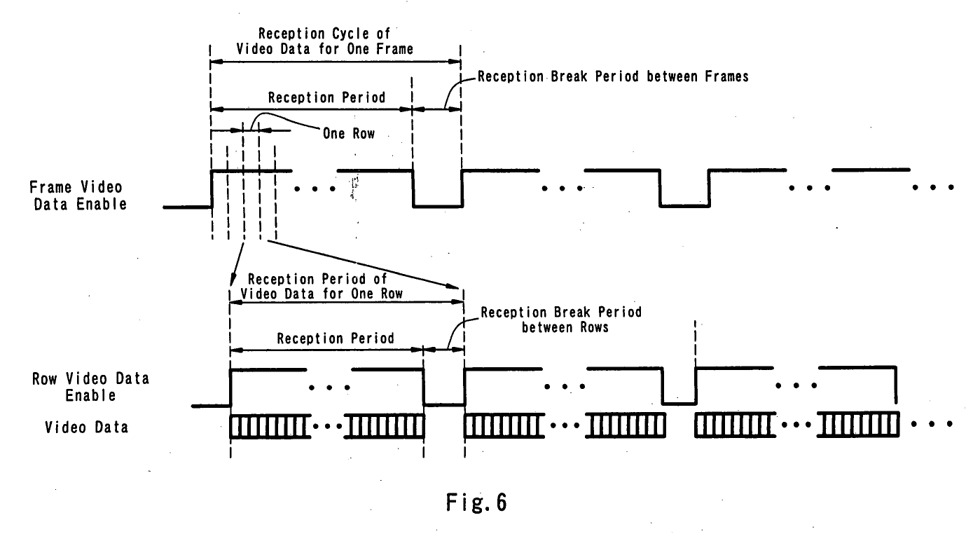

FIG. 6 is a timing chart illustrating a reception break period between adjacent frames and a reception break period between adjacent rows, in each of which the excess video data can be written. Similarly to the aforementioned video data for one sub-frame, video data for one frame and video data for one row each corresponds to a unit of data reading. In FIG. 6, “frame video data enable” indicates the timing of H/L level (H level here) at which the whole rows in one frame are selected, and “line video data enable” indicates the timing of H/L level (H level here) at which video data is inputted to a video line. That is, in a certain frame reception cycle, the period after the selection of the whole rows in one frame until the start of the next frame reception cycle corresponds to a reception period between adjacent frames. Similarly, the period after a video data input to a certain row until the next video data input to the next video line corresponds to a reception break period between adjacent rows. Video data is not read out in either period of the reception break period between frames and the reception break period between rows, therefore, the reception break period can be utilized for writing the excess video data.

By constructing the control circuit as shown in FIGS. 1A and 1B using a single memory as a main video data storage unit, which has an address area divided in half, reduction in the number of mounting pins, simpler configuration and smaller circuit scale can be achieved.

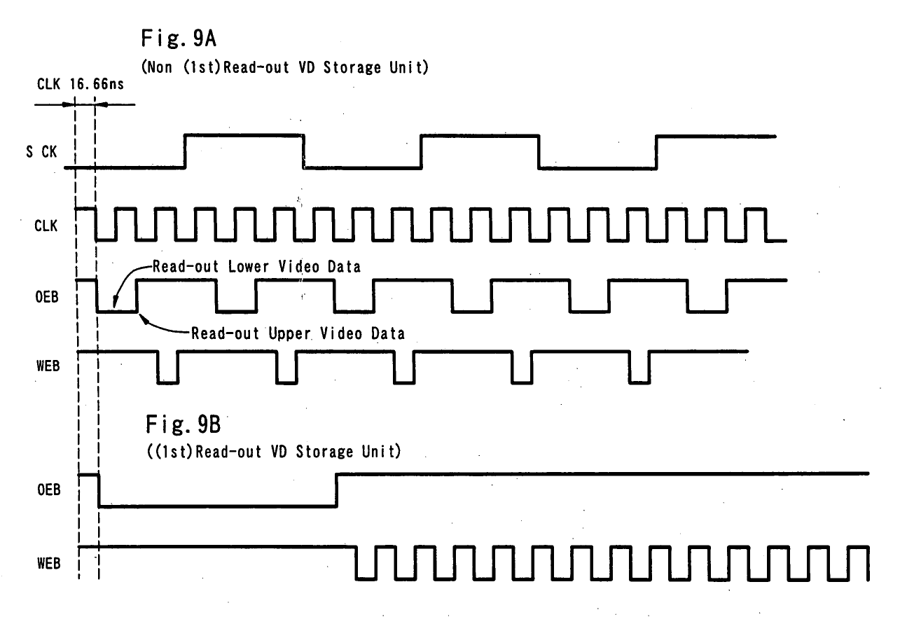

Further, by adopting a configuration where the read-out operation is performed continuously in the period of predetermined clocks as a base period, and the data read out is accumulated in the read-out video data storage unit 108 or the first read-out video data storage unit 108A, the read-out operation of video data can be performed with efficient utilization of time. FIG. 9 is a timing chart illustrating the read-out timing from the memory, in which a comparison is made between the case (A) where the read-out video data storage unit 108 (or the first read-out video data storage unit 108A) is not provided in a control circuit of a display device, and the case (B) where the read-out video data storage unit is provided in the control circuit of the display device. It illustrates the case where the internal clock (CLK) frequency is 60 MHz, and the half-cycle of S_CK is 100 ns. OEB denotes a read-out control signal and WEB denotes a write-in control signal, each of which is at L level in the enabled state (at read-out and write-in operations). In the case where no read-out video data storage unit is provided as shown in FIG. 9A, read-out operation is performed with the OEB being in the enabled state in synchronous with a half-cycle of S_CK. Such a case therefore involves a time margin for the period after the termination of the read-out operation for one address until the start of the next data read-out operation. Meanwhile, in the case where the read-out video data storage unit 108 (or the first read-out video data storage unit 108A) is provided as shown in FIG. 9B, such a time margin is not required. Thus, the read-out operation of video data can be performed with efficient utilization of time.

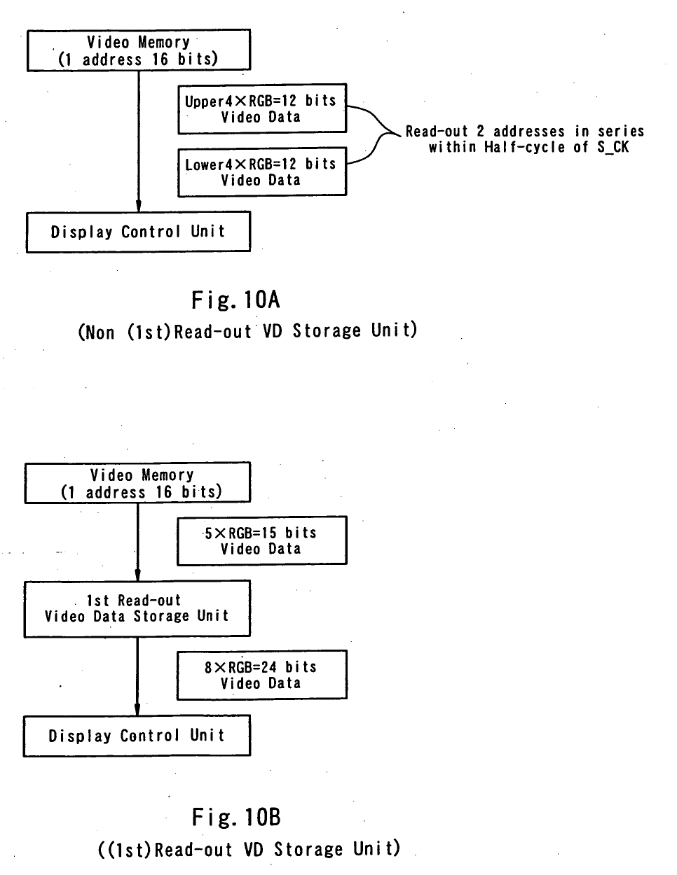

Further, by adopting a configuration where the read-out operation is performed continuously in asynchronous with a half-cycle of S_CK, and the video data read out is accumulated in the read-out video data storage unit 108 or the first read-out video data storage unit 108A, as large an area as possible of the main video data storage unit can be utilized efficiently. FIGS. 10A and 10B illustrate the condition of video data stored in each address of a memory, taking as an example the case where an image is displayed in a display panel by reading out video data for 8 pixels×RGB in parallel, and one address of the main video data storage unit is assigned with 16 bits. FIG. 10A illustrates a conventional control circuit having no read-out video data storage unit while FIG. 10B illustrates a control circuit of the invention having the read-out video data storage unit 108 or the first read-out video data storage unit 108A. In the conventional configuration, upper 12 bits (4 bits×RGB) are stored in one address while lower 12 bits (4 bits×RGB) are stored in the next address. Therefore, 2 addresses are read out in series within a half-cycle of S_CK, and thus 4 bits of the 16 bits of each address is not utilized. However, by adopting the configuration where the video data read out is accumulated in the read-out video data storage unit 108 or the first read-out video data storage unit 108A as in the control circuit of the invention, it becomes possible that video data of 15 bits (5×RGB) is accumulated in one address of the main video data storage unit 102 so that the video data is recompiled into video data for 8 pixels×RGB in the read-out video data storage unit 108 (or the first read-out video data storage unit 108A), thus one address has only one extra bit. Accordingly, a memory area used as the main video data storage unit can be utilized efficiently.

### Embodiment Mode 2

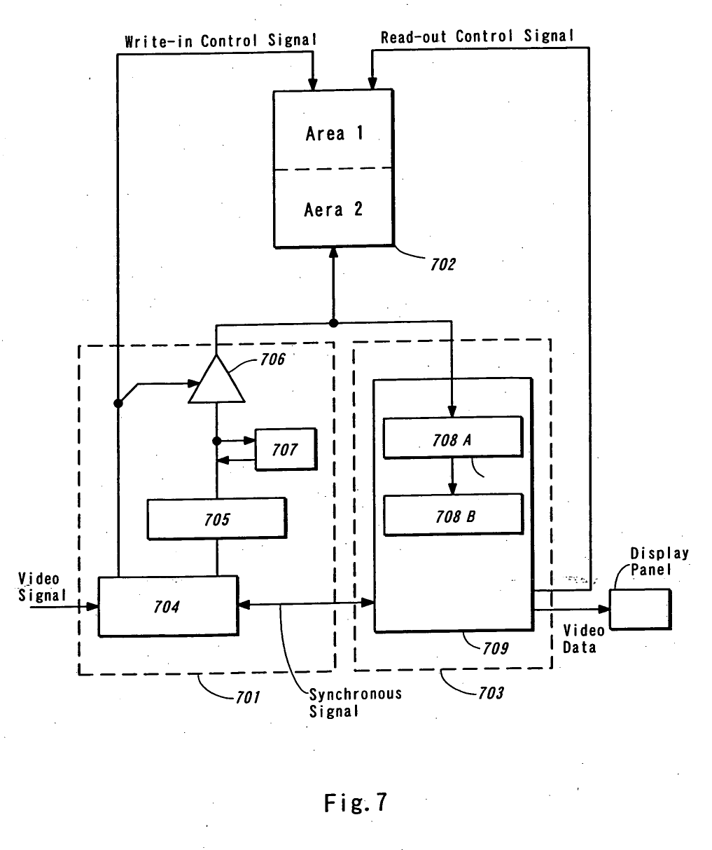

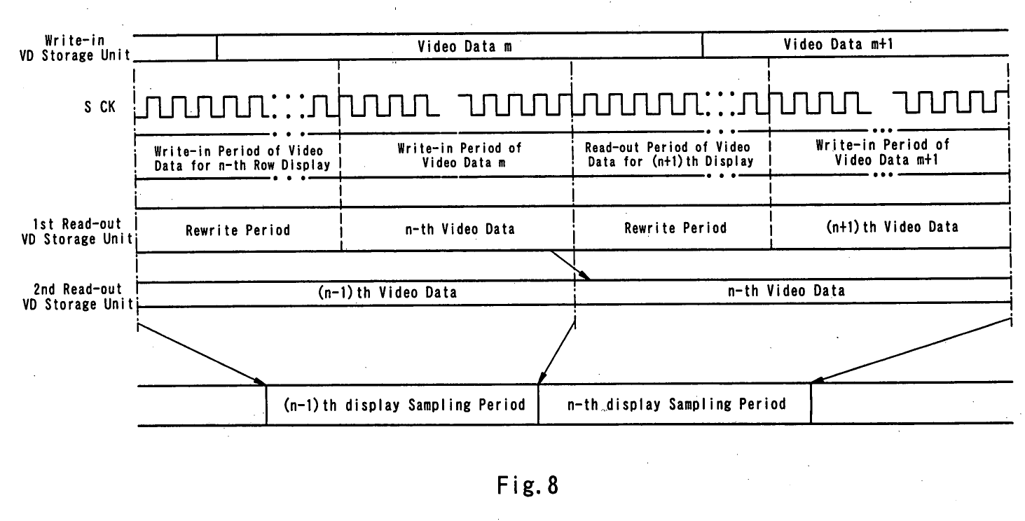

FIG. 7 is a schematic diagram illustrating an exemplary configuration of a control circuit of a display device of the invention, which is different from Embodiment Mode 1, and FIG. 8 illustrates the operation timing of the control circuit in Embodiment Mode 2 at read-out and write-in operations. This embodiment mode is similar to Embodiment Mode 1 in that the read-out operation is performed in asynchronous with a half-cycle of S_CK. However, in this embodiment, the read-out operation is performed not in predetermined clock cycles as a base period as in Embodiment Mode 1 in which the read-out operation is performed continuously, but the read-out operation is performed in the display cycle of one row in the display panel as a base period. Specifically, video data for one row that has an appropriate quantity for the display timing of the display panel is read out from the main video data storage unit within the base period, and then held in the read-out video data storage unit. Meanwhile, data writing to the main video data storage unit is performed in the period in which the read-out operation is not performed.

The control circuit in FIG. 7 has a similar configuration to the control circuit of Embodiment Mode 1 shown in FIG. 1A and FIG. 1B. The control circuit comprises a video data write-in circuit 701 including a video data format converting unit 704, a write-in video data storage unit 705, a tri-state buffer 706 and an excess video data storage unit 707, and the main video data storage unit 702 having an address area divided in half, which has a similar function to the control circuits in FIGS. 1A and 1B. The control circuit in FIG. 7 is also similar to the control circuits in FIGS. 1A and 1B in that the tri-state buffer 706 can be substituted with an analog switch and the like, and that the excess video data storage unit 705 is necessary only when there is the excess write-in video data.

Meanwhile, the control circuit in FIG. 7 is different from the control circuits in FIGS. 1A and 1B in that a video data read-out circuit has a display control circuit 709 incorporating a first read-out video data storage unit 708A and a second read-out video data storage unit 708B. Incorporation of the first and second read-out video data storage units 708A and 708B and the display control unit 709 into one integrated circuit facilitates downsizing of the circuit as well as the simpler configuration of the circuit, which leads to the improvement in reliability and reduction in production cost. However, the function per se of each component of the first and second readout data storage units 708A and 708B is similar to the control circuit in FIG. 1B. Thus, such a configuration is also possible that each of the first read-out video data storage unit 708A, the second read-out video data storage unit 708B and the display control unit 709 is separately provided. That is, either mode is possible where the aforementioned circuits are incorporated into one integrated circuit or provided separately. The control circuit in FIG. 7 is also similar to the control circuits in Embodiment Mode 1 in that the second read-out video data storage unit 708B is provided only when the transmission break period is not long enough for the first read-out video data storage unit 708A to read out the whole content of the main video data storage unit 702 by the next data transmission to the display panel.

Description is made below on the operation of the control circuit in FIG. 7. As shown in FIG. 8, in order to display an image, in the display period for one row of a display panel (in the display period of the (n-1)-th row, for example), video data corresponding to the n-th row is collectively read out from the video memory, and then stored in the first read-out video data storage unit 708A. In the display period of the subsequent row (n-th row), the video data corresponding to the n-th row, which is stored in the first read-out video data storage unit 708A, is transferred to the second read-out video data storage unit 708B to be transmitted to the display panel. Meanwhile, video data received is stored in the write-in video data storage unit 705 per several reception cycles, and the write-in operation to the main video data storage unit 702 is performed in the period in which the first read-out video data storage unit 708A is not being read out within the display period of a certain row. In FIG. 8, the m-th (m is a natural number) video data in a certain frame is denoted by the video data m.

As shown in FIG. 8, reception timing and display timing of video data are asynchronous with each other. Therefore, in actuality, the relationship between the read-out timing from the main video data storage unit and the display timing in the display panel are fixed, and the write-in operation to the main video data storage unit 702 is performed in the period in which the read-out operation is not performed. In the write-in operation, when the whole video data cannot be written to the video memory during the period in which the write-in video data storage unit 705 holds the video data m, for example, only the video data that has not been written to the video memory is accumulated in the excess video data storage unit 707, in which case the video data accumulated in the excess video data storage unit 707 is written to the main video data storage unit 702 during the display break period between adjacent sub-frames (FIG. 5) or the video data reception break period between adjacent rows or frames (FIG. 6).

Using a single memory having an address area divided in half, as the main video data storage unit 702 as in Embodiment Mode 1, reduction in the number of mounting pins, simpler configuration and smaller circuit scale can be achieved.

Further, by adopting a configuration where the read-out operation is performed not in synchronous with a half-cycle of S_CK, but continuously performed in the display cycle of one row in the display panel as a base period, and the video data read out is accumulated in the first read-out video data storage unit, the read-out operation does not involve a time margin for the period after the termination of the read-out operation for one address until the start of the next data read-out operation unlike FIG. 9 where the read-out operation is performed in synchronous with the half-cycle of S_CK Thus, the read-out operation of video data can be performed with efficient utilization of time.

Further, by adopting a configuration where the read-out operation is performed continuously in asynchronous with the half-cycle of S_CK, and the video data is accumulated in the first read-out video data storage unit, as large an area as possible of the main video data storage unit can be utilized efficiently (see FIGS. 10A and 10B).

### Embodiment 1

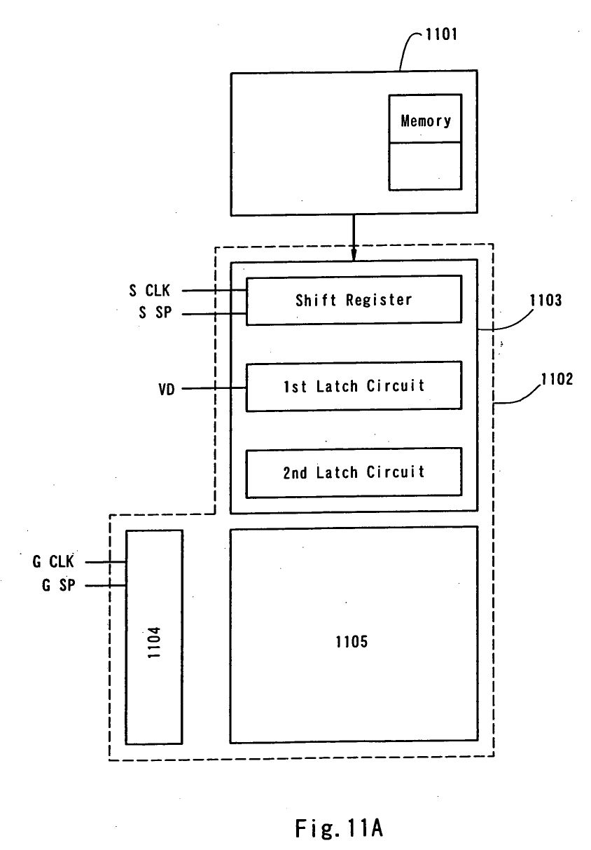

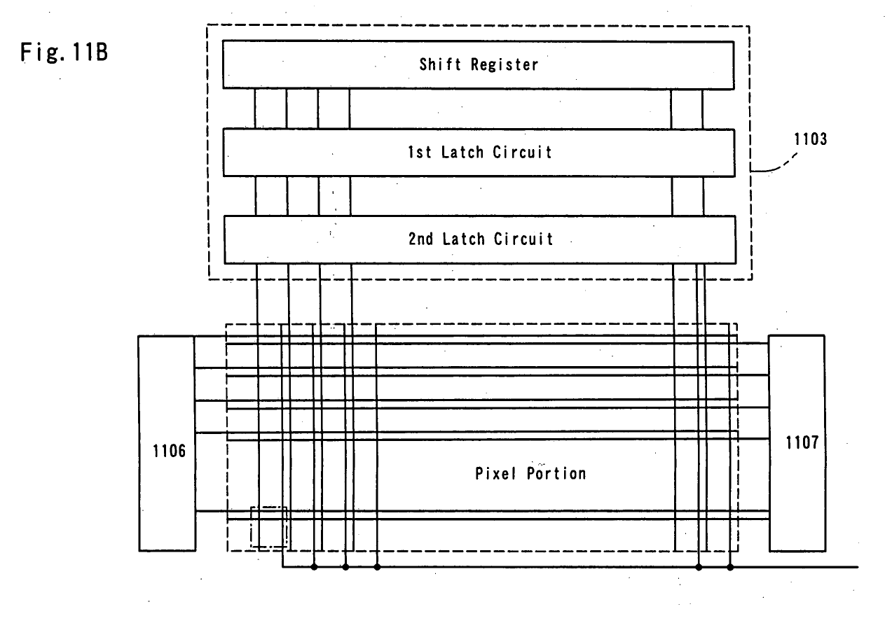

In this embodiment, description is made on an exemplary display device using the invention with reference to FIGS. 11A and 11B. A display device shown in FIG. 11A mainly comprises a control circuit 1101 having one video data memory for storing video data, and a display panel 1102 having pixels each of which includes a light emitting element such as an EL element. The control circuit 1101 may be, for example, the control circuit shown in FIGS. 1A, 1B or 7, which are described in Embodiment Modes 1 and 2. The display panel 102 includes a source driver 1103 connected to a source signal line, a gate driver 1104 connected to a gate signal line and a pixel portion 1105. The pixel portion includes pixels arranged in matrix. Each of the source driver 1103 and the gate driver 1104 may be a known driver circuit.

Although only a single gate driver is employed in this configuration, two gate drivers may be employed as shown in FIG. 11B where a write-in gate driver 1106 and an erase gate driver 1107 are provided.

Upon receiving a video signal, the control circuit 1101 converts the video signal in format to the video data enabling a gray scale display in each pixel with a time gray scale method, and transmits the video data to the source driver 1103 and the gate driver 1104 included in the display panel 1102 as well as other control signals, thereby an image is displayed in the pixel portion 1105 using EL elements.

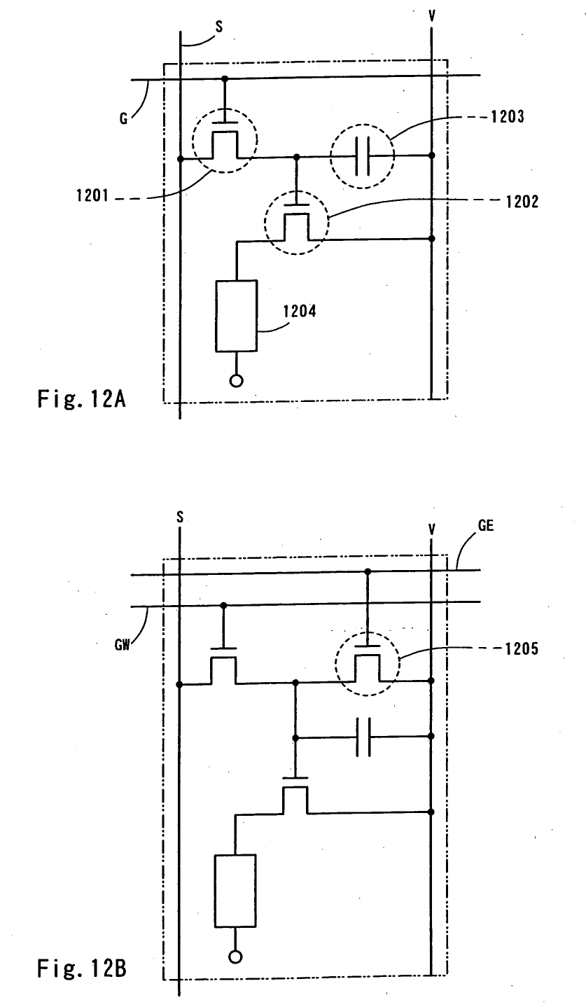

Each pixel includes a thin film transistor (hereinafter referred to as a TFT). FIG. 12A illustrates a configuration of a pixel portion of a display device. FIG. 12A illustrates a configuration where two TFTs are disposed in each pixel to control the emission and luminance of a light emitting element in each pixel. Each pixel includes a source signal line S, a gate signal line G, a power supply line V, a switching TFT 1201, a driving TFT 1202, a capacitor 1203 and a light emitting element 1204.

As shown in FIG. 12A, a gate electrode of the switching TFT 1201 is connected to the gate signal line G, and one of a source region and a drain region thereof is connected to the source signal line S while the other is connected to a gate electrode of the driving TFT 1202 and one electrode of the capacitor 1203. One of a source region and a drain region of the driving TFT 1202 is connected to the power supply line V while the other is connected to an anode or a cathode of the light emitting element 1204. One of two electrodes of the capacitor 1203 that is not connected to the driving TFT 1202 and the switching TFT 1201 is connected to the power supply line V.

In the case where the source region or the drain region of the driving TFT 1202 is connected to the anode of the light emitting element 1204, the anode of the light emitting element is called a pixel electrode while the cathode is called an opposite electrode. On the other hand, in the case where the source region or the drain region of the driving TFT 1202 is connected to the cathode of the light emitting element 1204, the cathode of the light emitting element 1204 is called a pixel electrode while the anode is called an opposite electrode. In addition, a potential supplied to the power supply line V is called a power supply potential while a potential supplied to the opposite electrode is called an opposite potential. The TFTs 1201 and 1202 may be either P-channel TFTs or N-channel TFTs, however, it is desirable that the driving TFT 1202 be a P-channel TFT and the switching TFT 1201 be an N-channel TFT when the pixel electrode of the light emitting element 1204 is the anode. When the pixel electrode is the cathode, on the other hand, it is desirable that the driving TFT 1202 be an N-channel TFT and the switching TFT 1201 be a P-channel TFT.

Description is made below on the operation of image display with a pixel having the aforementioned configuration. Upon input of a signal to the gate signal line G, a potential of the gate electrode of the switching TFT 1201 changes, thereby a gate voltage changes. Through the source and the drain of the switching TFT 1201 that is thusly ON, a signal is inputted to the gate electrode of the driving TFT 1202 from the source signal line S. Also, the signal is held in the capacitor 1203. By the signal inputted to the gate electrode of the driving TFT 1202, the gate voltage of the driving TFT 1202 changes, thereby the source and the drain thereof are electrically connected. A potential of the power supply line V is supplied to the pixel electrode of the light emitting element 1204 through the driving TFT 1202. Thus, the light emitting element 1204 emits light.

In the case of the display panel as shown in FIG. 11B where two gate drivers: the write-in gate driver 1106 and the erase gate driver 1107 are provided, a configuration providing three TFTs in each pixel is employed as shown in FIG. 12B. Specifically, an erasing TFT 1205 is connected in parallel with the capacitor 1203, the gate electrode of the switching TFT 1202 is connected to a write-in gate signal line GW that is driven by the write-in gate driver, and a gate electrode of the erasing TFT 1205 is connected to an erasing gate signal line GE that is driven by the erasing gate driver.

In either case where a single gate driver or two gate drivers are provided in this embodiment, the invention can be applied to the control circuit 1101 of the display device. According to the invention, simpler configuration and reduction in space of a control circuit of a display device are enabled. As a result, downsizing and reduction in production cost of the whole display device can be achieved.

### Embodiment 2

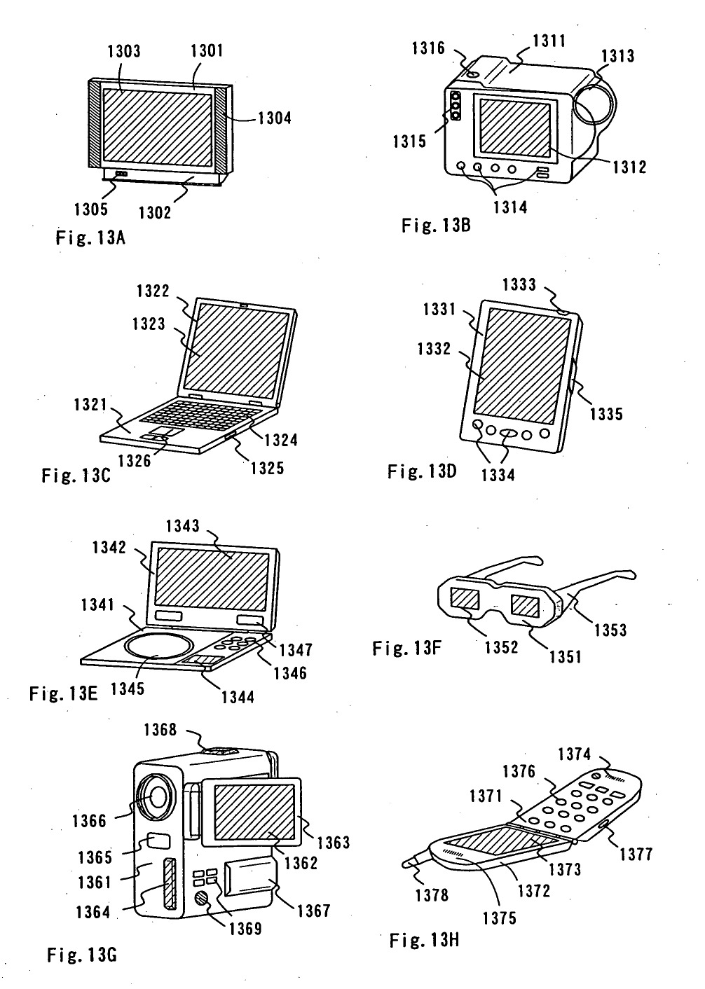

The invention can be applied to various electronic appliances such as a display device of a desktop, floor-stand or wall-mounted type, a video camera, a digital camera, a goggle display (head-mounted display), a navigation system, a sound reproducing device (e.g., car audio and audio component set), a computer, a game machine, a portable information terminal (e.g., mobile computer, portable phone, portable game machine and electronic book), and an image reproducing device provided with a recording medium (specifically, device for reproducing a video image or a still image recorded in a recording medium such as a Digital Versatile Disk (DVD), and having a display portion for displaying the reproduced image). Specific examples of such electronic appliances are shown in FIGS. 13A to 13H.

FIG. 13A illustrates a display of a desktop, floor-stand or wall-mounted type, which includes a housing 1301, a supporting base 1302, a display portion 1303, a speaker portion 1304, a video input terminal 1305 and the like. The invention can be applied to a control circuit of the display portion 1303, thereby downsizing of the display portion can be achieved as well as the downsizing and reduction in production cost of the whole device.

FIG. 13B illustrates a digital camera including a main body 1311, a display portion 1312, an image receiving portion 1313, operating keys 1314, an external connection port 1315, a shutter 1316 and the like. The invention can be applied to a control circuit of the display portion 1312, thereby downsizing of the display portion can be achieved as well as the downsizing and reduction in production cost of the whole device.

FIG. 13C illustrates a computer including a main body 1321, a housing 1322, a display portion 1323, a keyboard 1324, an external connection port 1325, a pointing mouse 1326 and the like. The invention can be applied to a control circuit of the display portion 1323, thereby downsizing of the display portion can be achieved as well as the downsizing and reduction in production cost of the whole device. Note that the computer includes a so-called laptop computer incorporated with a central processing unit (CPU) and a recording medium, and a so-called desktop computer unincorporated with them.

FIG. 13D illustrates a mobile computer including a main body 1331, a display portion 1332, a switch 1333, operating keys 1334, an IR port 1335 and the like. The invention can be applied to a control circuit of the display portion 1332, thereby downsizing of the display portion can be achieved as well as the downsizing and reduction in production cost of the whole device.

FIG. 13E illustrates a portable image reproducing device provided with a recording medium (specifically, a DVD reproducing device), which includes a main body 1341, a housing 1342, a first display portion 1343, a second display portion 1344, a recording medium (e.g., DVD) reading portion 1345, an operating key 1346, a speaker portion 1347 and the like. The first display portion 1343 mainly displays image data while the second display portion 1344 mainly displays text data. The invention can be applied to control circuits of the first and second display portions 1343 and 1344 respectively, thereby downsizing of the display portion can be achieved as well as the downsizing and reduction in production cost of the whole device. Note that the image reproducing device provided with a recording medium includes a home game machine and the like.

FIG. 13F illustrates a goggle display device (head-mounted display) including a main body 1351, a display portion 1352 and an arm portion 1353. The invention can be applied to a control circuit of the display portion 1352, thereby downsizing of the display portion can be achieved as well as the downsizing and reduction in production cost of the whole device.

FIG. 13G illustrates a video camera including a main body 1361, a display portion 1362, a housing 1363, an external connection port 1364, a remote control receiving portion 1365, an image receiving portion 1366, a battery 1367, a sound input portion 1368, operating keys 1369 and the like. The invention can be applied to a control circuit of the display portion 1362, thereby downsizing of the display portion can be achieved as well as the downsizing and reduction in production cost of the whole device.

FIG. 13H illustrates a portable phone including a main body 1371, a housing 1372, a display portion 1373, a sound input portion 1374, a sound output portion 1375, an operating key 1376, an external connection port 1377, an antenna 1378 and the like. The invention can be applied to a control circuit of the display portion 1373, thereby downsizing of the display portion can be achieved as well as the downsizing and reduction in production cost of the whole device.

The display device used in such electronic appliances may be constructed by using not only a glass substrate but also a heat-resistant plastic substrate, in which case further downsizing can be achieved.

Although the invention has been fully described by way of Embodiment Modes and Embodiments with reference to the accompanying drawings, it is to be understood that various changes and modifications will be apparent to those skilled in the art. Therefore, unless otherwise such changes and modifications depart from the scope of the invention hereinafter defined, they should be construed as being included therein. The present application is based on Japanese Priority application No. 2004-169392 filed on Jun. 8, 2004 with the Japanese Patent Office, the entire contents of which are hereby incorporated by reference.

1. A display device having a control circuit, the control circuit comprising:
main video data storage means including first and second areas for storing video data;
read-out means for reading out the video data from one of the first and second areas of the main video data storage means, and supplying the video data to a display panel; and
write-in means for converting a video signal supplied in format to video data enabling a gray scale display in the display device, and writing the video data to one of the first and second areas of the main video data storage means that is not being read out while the read-out operation of the video data is not performed,
wherein the read-out means switches the first and second areas to be read out the video data in each period in which one ore more images are displayed; and
wherein the read-out means reads out from the main video data storage means, a predetermined quantity of video data that is appropriate for the display timing of the display panel in a plurality of consecutive clock cycles.

2. The display device according to claim 1, wherein the readout means includes a read-out video data storage means for holding the predetermined quantity of video data for a fixed hold period

3. The display device according to claim 2, wherein the read-out video data storage means includes first read-out video data storage means for holding video data that is read out from the main video storage means for a fixed period, and second read-out video data storage means for reading out video data from the first read-out video data storage means all at once at regular intervals.

4. The display device according to claim 1, wherein the read-out means is incorporated into one integrated circuit.

5. The display device according to claim 1, wherein the write-in means includes write-in video data storage means for holding the predetermined quantity of video data that is appropriate for being written to the main video data storage means for a fixed write-in video data hold period so as to write the video data to the main video data storage means.

6. The display device according to claim 1, wherein the write-in means includes excess video data storage means for temporarily holding a part of the predetermined quantity of video data held in the write-in video data storage means, which has not been written to the main video data storage means during the write-in video data hold period, and for writing the video data to the main video data storage means while the read-out operation of the video data is not being performed.

7. The display device according to claim 1, wherein the display device includes a display panel having pixels each of which includes a light emitting element.

8. The display device according to claim 7, wherein the light emitting element is an EL element.

9. An electronic appliance comprising the display device according to claim 1, wherein the electronic appliance is selected from the group consisting of a digital camera, a goggle display (head-mounted display), a navigation system, a sound reproducing device, a computer, a game machine, a portable information terminal, and an image reproducing device provided with a recording medium

10. A display device comprising:
main video data storage unit including first and second areas for storing video data;
a read-out circuit for reading out the stored video data from one of the first and second areas of the main video data storage unit; and
a write-in circuit for writing video data to one of the first and second areas of the main video data storage unit that is not being read out while the read-out operation of the stored video data is not performed.

11. The display device according to claim 10, wherein the read-out circuit includes a read-out video data storage circuit for holding the predetermined quantity of video data for a fixed hold period

12. The display device according to claim 11, wherein the read-out video data storage circuit includes a first read-out video data storage unit for holding video data that is read out from the main video storage unit for a fixed period, and a second read-out video data storage unit for reading out video data from the first read-out video data storage unit all at once at regular intervals.

13. The display device according to claim 10, wherein the read-out circuit is incorporated into one integrated circuit.

14. The display device according to claim 10, wherein the write-in circuit includes a write-in video data storage unit for holding the predetermined quantity of video data that is appropriate for being written to the main video data storage means for a fixed write-in video data hold period so as to write the video data to the main video data storage unit.

15. The display device according to claim 10, wherein the write-in circuit includes an excess video data storage unit for temporarily holding a part of the predetermined quantity of video data held in the write-in video data storage unit, which has not been written to the main video data storage unit during the write-in video data hold period, and for writing the video data to the main video data storage unit while the read-out operation of the video data is not being performed.

16. The display device according to claim 10, wherein the display device includes a display panel having pixels each of which includes a light emitting element.

17. The display device according to claim 16, wherein the light emitting element is an EL element.

18. An electronic appliance comprising the display device according to claim 10, wherein the electronic appliance is selected from the group consisting of a digital camera, a goggle display (head-mounted display), a navigation system, a sound reproducing device, a computer, a game machine, a portable information terminal, and an image reproducing device provided with a recording medium

19. A driving method of a control circuit of a display device, which converts a video signal supplied in format to video data enabling a gray scale display in the display device to be supplied to a display panel, and which comprises a main video data storage means including first and second areas for storing the video data, the driving method comprising the steps:
reading out a predetermined quantity of video data appropriate for the display timing of the display panel continuously in a plurality of consecutive clock cycles from one of the first and second areas of the main video data storage means;
supplying video data readout from the main video data storage unit to the display panel;
converting the video signal supplied in format to the video data, and writing the video data to one of the first and second areas of the main video data storage means that is not being read out while the read-out operation of the video data is not performed; and
switching the first and second areas to be read out the video data in each period for displaying one more images.
